(19) United States
(12) Patent Application Publication
(10) Pub. No.: US 2016/0068656 A1
(43) Pub. Date: Mar. 10, 2016

(54) CELLULOSE ESTER PLASTICS AND METHODS AND ARTICLES RELATING THERETO

(71) Applicant: Celanese Acetate LLC, Irving, TX (US)

(72) Inventors: Naresh Budhavaram, Florence, KY (US); Lizbeth Milward Niebla, Kennesaw, GA (US); Michael Combs, Pembroke, VA (US); Wendy C. Bisset, Eggleston, VA (US); Nagarjuna Palyam, Cincinnati, OH (US); Christopher McGrady, Florence, KY (US); Marilyn T. Collins, Florence, KY (US); Bing Lu, Union, KY (US); Adam Larkin, Dallas, TX (US); Syed Mazahir, Cincinnati, OH (US)

(73) Assignee: Celanese Acetate LLC, Irving, TX (US)

(21) Appl. No.: 14/848,732

(22) Filed: Sep. 9, 2015

Related U.S. Application Data
(60) Provisional application No. 62/048,001, filed on Sep. 9, 2014.
(60) Provisional application No. 62/047,930, filed on Sep. 9, 2014.
(60) Provisional application No. 62/047,888, filed on Sep. 9, 2014.

(51) Int. Cl. C08K 5/12; C08K 5/1565; C08L 1/12

(52) U.S. Cl. CPC C08K 5/12; C08L 1/12; C08K 5/1565

(57) ABSTRACT

Cellulose ester plastics may be formulated to have a depressed melt processing temperatures, improved heat resistance, increased mechanical stability, or some combination thereof. For example, in some instances, a cellulose ester plastic comprising: a cellulose ester at about 20% to about 90% by weight of the cellulose ester plastic; and a plasticizer that comprises a carbonate ester, a polyol benzoate, or both, wherein the plasticizer is at about 2% to about 40% by weight of the cellulose ester plastic, wherein the cellulose ester plastic is melt processable.

### BACKGROUND

The exemplary embodiments described herein relate to cellulose ester plastic compositions, and methods and articles relating thereto.

Cellulose esters are generally considered environmentally-friendly polymers because they are recyclable, degradable, and derived from renewable sources like wood pulp. Despite this, cellulose esters have not been widely used in plastic compositions due to processing difficulties.

Of particular note is the absence of cellulose esters in injection molded articles. This is due, at least in part, to the narrow temperature window between the melting point and the decomposition temperature of cellulose esters. Insufficient melting or decomposition of cellulose esters may plug injection molding equipment and reduced mechanical properties of the injection molded articles.

In some instances, plasticizers may be used to depress the melting point, which allows for lower temperature processing of the cellulose esters to mitigate decomposition. However, the plasticizer also decreases the deflection temperature under load (DTUL) (also referred to as heat deflection temperature) of the injection molded articles. As used herein, the term “DTUL” refers to the temperature at which a plastic sample deforms under a specific load.

The DTUL of a plastic composition provides an indication of how the plastic composition can be used in articles (i.e., the temperature and load that the plastic composition or article produced therewith can withstand for prolonged periods of time). For example, medical articles that are sterilized by autoclave and automotive interior parts should be produced with a plastic composition having a higher DTUL than a plastic composition used to make plastic bags and storage boxes.

In some instances, fillers have been used to increase the DTUL of plasticized cellulose esters. However, fillers can have an opposite effect to the plasticizer and increase the melt processing temperature of the plasticized cellulose esters. In some instances, fillers may render the cellulose ester plastics not melt processable. Additionally, fillers increase the opacity of the cellulose ester plastic, which is unwanted in applications like plastic bags. Therefore, melt processable plasticized cellulose esters with increased DTUL and enhanced mechanical properties that utilize little to no filler may be of value in forming injection molded articles.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1 is an exemplary piston stroke-temperature plot used for determine the flow initiation temperature.

FIG. 2 is a plot of DTUL at 1.8 MPa versus the percent plasticizer for several cellulose ester plastics.

FIG. 3 is a plot of melt flow index versus the percent polypropylene for several cellulose ester plastics.

FIG. 4 is a plot of Charpy notched impact strength versus the percent polypropylene for several cellulose ester plastics.

FIG. 5 is a plot of DTUL versus the percent polypropylene for several cellulose ester plastics.

### DETAILED DESCRIPTION

The exemplary embodiments described herein relate to cellulose ester plastic compositions (also referred to herein as “cellulose ester plastics”), and injection molding methods and injection molded articles relating thereto. More specifically, the cellulose ester plastic compositions that are melt processable and produce injection molded articles with an elevated DTUL of about 50° C. at 1.8 MPa and enhanced mechanical properties like at least 2000 MPa tensile strength.

As used herein, the terms “melt processable” and derivations thereof refer to compositions that form homogeneous pellets when processed according to the following procedure: (1) compounding the components of the composition at the throughput rate of 40 lb/hr with screw speed of 250 rpm at melt temperature 210° C. in a 25 mm twin screw extruder (e.g., a Krupp-Werner & Pfleiderer ZSK-25 extruder) to form a melt, (2) extruding the melt through a die head with 2 mm die hole at 210° C. into a 25° C. water bath to form a plastic string where during extrusion the melt is maintained at 210° C., and (3) chopping the plastic string with a pelletizer (e.g., a Cumberland pelletizer) into pellets or lengths of 5 mm. The resultant pellets are considered “homogeneous” when at least 80% of the pellets formed vary in weight by 10% or less. It should be noted that the term “melt processable plastic” or variations thereof does not imply that the plastic was prepared by the foregoing method, but rather that a “melt processable plastic” when processed by the foregoing method produces homogenous pellets.

Cellulose ester plastics described herein may comprise a cellulose ester and a plasticizer. In some instances, cellulose ester plastics may optionally further comprise a polyolefin blended with the plasticized cellulose ester. As used herein, the term “plasticized cellulose ester” refers to a composition consisting of one or more cellulose esters and one or more plasticizers where other additives and components blended therewith are delineated separately.

The cellulose ester plastics described herein may utilize carbonate ester plasticizers, polyol benzoate plasticizers, or both and optionally in further combination with other plasticizers. The carbonate ester plasticizers and polyol benzoate plasticizers advantageously and unexpectedly produce plasticized cellulose esters and plastic compositions thereof with enhanced DTUL as compared to traditional plasticizers like triacetin and diacetin. More specifically, carbonate ester plasticizers appear to be more efficient plasticizers. Accordingly, less plasticizer may be used, which increases the DTUL of the cellulose ester plastic. Additionally, carbonate ester plasticizers may be used at concentrations lower than traditional plasticizers to achieve melt processable plasticized cellulose esters. By way of nonlimiting example, cellulose acetate plasticized with about 15% propylene carbonate is melt processable, whereas cellulose acetate plasticized with less than 20% triacetin is not melt processable (under the same conditions).

Further, polyol benzoate plasticizers enhance DTUL by increasing the DTUL for the same concentration of plasticizer. By way of nonlimiting example, cellulose acetate plasticized with about 28% glyceryl tribenzoate has a DTUL about 15% greater than cellulose acetate plasticized with 28% triacetin.

Further, the maximum DTUL for a plasticized cellulose acetate with traditional plasticizers appears to be about 70° C. By contrast, carbonate ester plasticizers and polyol benzoate plasticizers have unexpectedly produced plasticized cellulose acetates with a DTUL of over 90° C. and over 85° C., respectively.

Cellulose esters may be included in the cellulose ester plastics described herein at concentrations of about 1% to about 90% by weight of the cellulose ester plastic. Subsets of the foregoing range that may also be applicable include about 1% to about 10%, about 1% to about 20%, about 20% to about 75%, about 50% to about 90%, about 60% to about 90%, by weight of the cellulose ester plastic. Cellulose esters may be included in the plasticized cellulose esters described herein at concentrations of about 60% to about 90% by weight of the plasticized cellulose ester. Subsets of the foregoing range that may also be applicable include about 60% to about 70%, about 60% to about 80%, about 70% to about 80%, about 70% to about 90%, or about 80% to about 90% by weight of the plasticized cellulose ester.

Cellulose esters suitable for use in the cellulose ester plastics described herein may have ester substituents that include, but are not limited to, C₁-C₂₀ aliphatic esters (e.g., acetate, propionate, or butyrate), functional C₁-C₂₀ aliphatic esters (e.g., succinate, glutarate, maleate) aromatic esters (e.g., benzoate or phthalate), substituted aromatic esters, and the like, any derivative thereof, and any combination.

Cellulose esters suitable for use in the cellulose ester plastics described herein may have a degree of substitution of the ester substituent at about 0.5 to about 3. Subsets of the foregoing range that may also be applicable include about 0.5 to about 1.2, about 1.2 to about 2.5, about 2 to about 3, about 1.2 to about 2.7, about 0.5 to about 2.4, about 1.2 to about 2.4, or about 2.4 to about 3.

Cellulose esters suitable for use in the cellulose ester plastics described herein may have a molecular weight of about 10,000 to about 300,000. Subsets of the foregoing ranges that may also be applicable include about 10,000 to about 150,000, about 10,000 to about 100,000, about 10,000 to about 50,000, about 25,000 to about 300,000, about 25,000 to about 150,000, about 25,000 to about 100,000, about 25,000 to about 50,000, about 50,000 to about 300,000, about 50,000 to about 150,000, or about 50,000 to about 100,000. As used herein, the term “molecular weight” refers to a polystyrene equivalent number average molecular weight (Mn).

Plasticizers may be included at concentrations of about 2% to about 40% by weight of the cellulose ester plastic. Subsets of the foregoing range that may also be applicable include about 2% to about 35%, about 5% to about 30%, about 5% to about 15%, about 10% to about 40%, about 10% to about 25%, or about 25% to about 40% by weight of the cellulose ester plastic. Plasticizers may be included in the plasticized cellulose esters described herein at concentrations of about 10% to about 40% by weight of the plasticized cellulose ester. Subsets of the foregoing range that may also be applicable include about 10% to about 20%, about 10% to about 30%, about 20% to about 30%, about 20% to about 40%, or about 30% to about 40% by weight of the plasticized cellulose ester.

Exemplary carbonate esters may be according to Formula 1 or Formula 2:

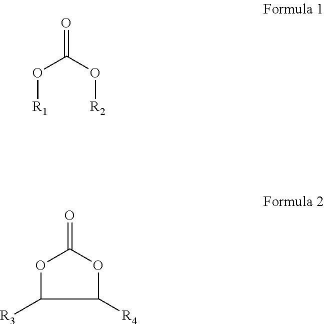

wherein R1 and R2 are each independently C₁-C₁₆ alkyl or aryl; and wherein R3 and R4 are each independently hydrogen or C₁-C₁₂ alkyl. As used herein, “alkyl” refers to a substituent with C and H that may be linear or branched (e.g., t-butyl) and saturated or unsaturated. As used herein, “aryl” refers to an aromatic ring that may include phenyl, naphthyl, and aromatic rings with heteroatoms.

Specific examples of carbonate esters may include, but are not limited to, propylene carbonate, butylene carbonate, diphenyl carbonate, phenyl methyl carbonate, dicresyl carbonate, glycerin carbonate, dimethyl carbonate, diethyl carbonate, ethylene carbonate, propylene carbonate, isopropylphenyl 2-ethylhexyl carbonate, phenyl 2-ethylhexyl carbonate, isopropylphenyl isodecyl carbonate, isopropylphenyl tridecyl carbonate, phenyl tridecyl carbonate, and the like, and any combination thereof.

Specific examples of polyol benzoates may include, but are not limited to, glyceryl tribenzoate, propylene glycol dibenzoate, diethylene glycol dibenzoate, dipropylene glycol dibenzoate, triethylene glycol dibenzoate, polyethylene glycol dibenzoate, neopentylglycol dibenzoate, trimethylolpropane tribenzoate, trimethylolethane tribenzoate, pentaerythritol tetrabenzoate, sucrose benzoate (with a degree of substitution of 1-8), and combinations thereof. In some instances, tribenzoates like glyceryl tribenzoate may be preferred. In some instances, polyol benzoates may be solids at 25° C. and a water solubility of less than 0.05 g/100 mL at 25° C.

In some instances, cellulose ester plastics described herein may comprise carbonate ester plasticizers, polyol benzoate plasticizers, and other plasticizers. The inclusion of the carbonate ester plasticizers and/or polyol benzoate plasticizers may increase the DTUL. In some alternative embodiments, a cellulose ester plastic described herein may be free (i.e., 0% by weight of cellulose ester plastic) or substantially free (i.e., less than about 5% of cellulose ester plastic) of traditional plasticizers like triacetin, diacetin, diethyl phthalate, triethyl citrate, acetyl triethyl citrate, epoxidized soybean oil, and combinations thereof.

If other plasticizers are included, cellulose ester plastics described herein may be formulated with a ratio of the carbonate ester plasticizers, polyol benzoate plasticizers, or combination thereof to the other plasticizers that is about 5:1 to about 1:5. Subsets of the foregoing range that may also be applicable include about 5:1 to about 1:1, about 2:1 to about 1:1, about 1:1 to about 1:5, about 1:1 to about 1:2, or about 2:1 to about 2:1. Described alternatively, if other plasticizers are included, the carbonate ester plasticizers, polyol benzoate plasticizers, or combination thereof may compose about 15% to about 85% by weight of the plasticizer, and the other plasticizers composes the remaining portion of the plasticizer (i.e., at about 85% to about 15% by weight of the plasticizer). Subsets of the foregoing ranges for either plasticizer portion that may also be applicable include about 15% to about 35%, about 65% to about 85%, about 25% to about 75%, about 50% to about 75%, or about 25% to about 50% by weight of the plasticizer.

Exemplary plasticizers that may be used in combination with, be omitted from, or be substantially omitted from the cellulose ester plastics described herein may include, but are not limited to, triacetin, trimethyl phosphate, triethyl phosphate, tributyl phosphate, triphenyl phosphate, triethyl citrate, acetyl trimethyl citrate, acetyl triethyl citrate, acetyl tributyl citrate, tributyl-o-acetyl citrate, dibutyl phthalate, diaryl phthalate, diethyl phthalate, dimethyl phthalate, di-2-methoxyethyl phthalate, di-octyl phthalate (and isomers), dibutyl tartrate, ethyl o-benzoylbenzoate, ethyl phthalyl ethyl glycolate, methyl phthalyl ethyl glycolate, n-ethyltoluenesulfonamide, o-cresyl p-toluenesulfonate, aromatic diol, substituted aromatic diols, aromatic ethers, tripropionin, tribenzoin, polycaprolactone, glycerin, glycerin esters, diacetin, glycerol acetate benzoate, polyethylene glycol, polyethylene glycol esters, polyethylene glycol diesters, di-2-ethylhexyl polyethylene glycol ester, glycerol esters, diethylene glycol, polypropylene glycol, polyglycoldiglycidyl ethers, dimethyl sulfoxide, N-methyl pyrollidinone, C₁-C₂₀ dicarboxylic acid esters, dimethyl adipate (and other dialkyl esters), di-butyl maleate, di-octyl maleate, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, alkyl lactones (e.g., γ-valerolactone), alkylphosphate esters, aryl phosphate esters, phospholipids, aromas (including some described herein, e.g., eugenol, cinnamyl alcohol, camphor, methoxy hydroxy acetophenone (acetovanillone), vanillin, and ethylvanillin), 2-phenoxyethanol, glycol ethers, glycol esters, glycol ester ethers, polyglycol ethers, polyglycol esters, ethylene glycol ethers, propylene glycol ethers, ethylene glycol esters (e.g., ethylene glycol diacetate), propylene glycol esters, polypropylene glycol esters, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, butylated hydroxytoluene, butylated hydroxyanisol, sorbitol, xylitol, ethylene diamine, piperidine, piperazine, hexamethylene diamine, triazine, triazole, pyrrole, and the like, any derivative thereof, and any combination thereof.

As described previously, cellulose ester plastics described herein may include cellulose esters, plasticizers (the carbonate ester plasticizers, polyol benzoate plasticizers, or combination thereof and optionally other plasticizers), and polyolefins. If used, polyolefins may be included at concentrations of about 1% to about 99% by weight of the cellulose ester plastic. Subsets of the foregoing range that may also be applicable include about 1% to about 50%, about 10% to about 75%, about 10% to about 50%, about 1% to about 25%, about 5% to about 25%, about 25% to about 50%, or about 50% to about 99% by weight of the cellulose ester plastic.

Specific examples of polyolefins may include, but are not limited to, polyethylene, polypropylene, polymethylpentene, poly(1-butene), polyisobutylene, and any copolymer thereof, and any combination (or polymer blend) thereof. In some instances, the polyolefin may be a low density polyolefin having a density of about 0.910 g/cm³ to about 0.925 g/cm³. In some instances, the polyolefin may be a linear low density polyolefin having a significant number of short branches and a density of about 0.91 g/cm³ to about 0.94 g/cm³. In some instances, the polyolefin may be a medium density polyolefin having a density of about 0.926 g/cm³ to about 0.940 g/cm³. In some instances, the polyolefin may be a high density polyolefin having a density of about 0.941 g/cm³ to about 0.965 g/cm³. In some instances, the polyolefin may be an ultrahigh molecular weight polyolefin having a molecular weight of about 3×10⁶ to about 6×10⁶ and a density of about 0.928 g/cm³ to about 0.941 g/cm³.

In some instances, the cellulose ester plastic may include no filler. In some instances, a filler may optionally be included up to about 500% by weight of the cellulose ester plastic. Subsets of the foregoing ranges that may also be applicable include about 0.1% to about 50%, about 5% to about 40%, about 5% to about 30%, about 5% to about 15%, about 10% to about 50%, about 10% to about 25%, or about 25% to about 50% by weight of the cellulose ester plastic.

Examples of fillers may include, but are not limited to, coconut shell flour, walnut shell flour, wood flour, wheat flour, soybean flour, gums, protein materials, calcium carbonate, talc, zeolite, clay, rigid compounds (e.g. lignin), thickeners, unreacted starches, modified starches (e.g., with modifications other than ester modifications like hydroxyethyl starch, hydrolyzed starch, cationic starch, starch phosphate, oxidized starch, and the like), waxy starches, cellulose nanofibrils, nanocrystalline cellulose, glass microspheres, glass fibers, carbonates, talc, silica, silicates, magnesium silicates, and the like, and any combination thereof.

In some instances, a cellulose ester plastic described herein may further comprise one or more additives like a compatibilizer, an antioxidant, a softening agent, a flame retardant, a pigment and/or dye, a flavorant, an aroma, an adhesive, a tackifier, a lubricating agent, a vitamin, a biocide, an antifungal, an antimicrobial, an antistatic agent, an antifoaming agent, a degradation agent, a conductivity modifier, impact modifiers, or combinations thereof.

Compatibilizers may be useful in cellulose ester plastics that include polyolefins to enhance the blending of the cellulose esters and the plasticizers with the polyolefins. For example, glyceryl tribenzoate may bloom (i.e., move towards the surface and out of the composition) in articles comprising cellulose esters, glyceryl tribenzoate, and polyolefins. Compatibilizers (e.g., polyethylene glycol) may mitigate the blooming by compatibilizing the glyceryl tribenzoate with the polyolefin.

Exemplary compatibilizers may be nonionic surfactants that include, but are not limited to, polysorbates (e.g., TWEEN®20 or TWEEN@80, available from SigmaAldrich), sorbitan esters (e.g., SPAN® products available from SigmaAldrich), polyethoxylated aromatic hydrocarbons (e.g., TRITON® products available from SigmaAldrich), polyethoxylated fatty acids, polyethoxylated fatty alcohols (e.g., BRIJ® products available from SigmaAldrich), fluorosurfactants, glucosides, and other nonionic surfactants with hydrocarbon tails (e.g., C₆-C₂₂ alkyl groups) and hydrophilic head groups with hydroxyl and ester groups, and combinations thereof. Additional exemplary compatibilizers may be polyethylene glycol (PEG) less than about 10,000 molecular weight (e.g., PEG-300). Combinations of the foregoing may also be used. In some embodiments, compatibilizers may be present in a cellulose ester plastic in an amount of about 0.1% to about 20% by weight of the cellulose ester plastic. Subsets of the foregoing range that may also be applicable include about 1% to about 20%, about 5% to about 20%, about 0.1% to about 10%, about 1% to about 10%, about 0.1% to about 5%, or about 10% to about 20% by weight of the cellulose ester plastic.

The cellulose ester plastics described herein may be prepared by compounding the components of the cellulose ester plastic (e.g., the cellulose esters, the plasticizers, optionally the polyolefins, and optionally the additives) at a temperature of about 170° C. to about 250° C. By way of nonlimiting example, a twin-screw extruder may be used to compound cellulose acetate, polyethylene, one or more plasticizers (e.g., carbonate ester(s) and/or polyol benzoate(s)), and a pigment or dye. Then, pellets or like may be extruded, which can later be melted and used in injection molding techniques to form injection molded articles (e.g., parts for a vehicle interior).

The cellulose ester plastics described herein may have one or more of the following properties that allows for performing injection molding processes therewith: a flow initiation temperature of about 130° C. to about 230° C., a glass transition temperature of about 40° C. to about 180° C., a melt flow index (MFI) (with a 300 sec melt time and at 210° C./2.16 kg measured in accordance with ASTM D1238) of about 0.1 g/10 min to about 75 g/10 min, or a melt viscosity at 210° C. and 1000 s¹ of about 10 Pa*s to about 500 Pa*s.

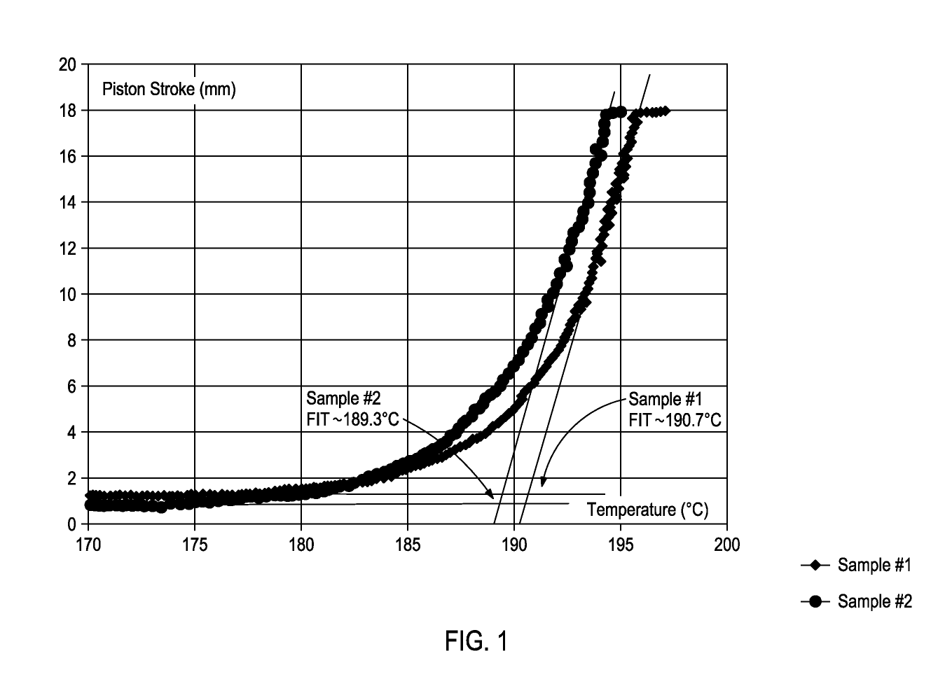

Unless otherwise specified, as used herein the flow initiation temperature is measured with a capillary rheometer (e.g., a Shimadzu CFT-500D) using a constant heating-rate method at 4° C./min ramp rate, 100 kg force, and a 1 mm die. The resultant piston stroke-temperature plot (FIG. 1) may be used to determine the flow initiation temperature, which is the intersection of the tangent of the base line and the tangent of the final flow line as illustrated in FIG. 1 for two different samples. In some embodiments, the cellulose ester plastics described herein may have a flow initiation temperature of about 130° C. to about 230° C. Subsets of the foregoing range that may also be applicable include about 130° C. to about 210° C., about 130° C. to about 200° C., about 150° C. to about 230° C., about 150° C. to about 210° C., about 150° C. to about 200° C., about 180° C. to about 230° C., about 180° C. to about 210° C., about 180° C. to about 200° C., about 200° C. to about 230° C., or about 200° C. to about 210° C.

The glass transition temperature of a cellulose ester plastic can be measured by either differential scanning calorimetry or rheology. In some embodiments, the cellulose ester plastics described herein may have a glass transition temperature of about 40° C. to about 180° C. Subsets of the foregoing range that may also be applicable include about 40° C. to about 150° C., about 40° C. to about 90° C., about 75° C. to about 180° C., 75° C. to about 150° C., about 75° C. to about 90° C., about 90° C. to about 180° C., 90° C. to about 150° C., or about 90° C. to about 125° C.

In some embodiments, the cellulose ester plastics described herein may have a MFI (with a 300 sec melt time and at 210° C./2.16 kg measured in accordance with ASTM D1238) of about 0.1 g/10 min to about 75 g/10 min. Subsets of the foregoing range that may also be applicable include about 0.1 g/10 min to about 50 g/10 min, about 0.1 g/10 min to about 25 g/10 min, about 0.1 g/10 min to about 15 g/10 min, about 1 g/10 min to about 75 g/10 min, about 1 g/10 min to about 25 g/10 min, about 1 g/10 min to about 15 g/10 min, about 5 g/10 min to about 75 g/10 min, about 5 g/10 min to about 25 g/10 min, about 10 g/10 min to about 75 g/10 min, or about 10 g/10 min to about 25 g/10 min.

The melt viscosity of cellulose ester plastics described herein may be measured by rheometers (rotational, or capillary). In some embodiments, the cellulose ester plastics described herein may have a melt viscosity at 210° C. and 1000 s¹ of about 10 Pa*s to about 500 Pa*s. Subsets of the foregoing range that may also be applicable include about 10 Pa*s to about 300 Pa*s, about 10 Pa*s to about 150 Pa*s, about 50 Pa*s to about 500 Pa*s, about 50 Pa*s to about 300 Pa*s, about 50 Pa*s to about 150 Pa*s, about 100 Pa*s to about 500 Pa*s, about 100 Pa*s to about 300 Pa*s, or about 100 Pa*s to about 150 Pa*s. In some instances, lower melt viscosity may be preferable when melt processing plastics into articles.

In some instances, injection molding processes may be performed at temperature of about 190° C. to about 240° C. Advantageously, the carbonate ester and/or polyol benzoate plasticizers may, in some instances, be retained in the cellulose ester plastic during injection molding techniques, which allows for the beneficial mechanical properties and DTUL to be realized in the injection molded article. In some instances, the percent weight loss of the plasticizer may be less than 0.5% (or less than 0.3% or less than 0.1%) during injection molding methods. This weight loss may be calculated by the weight of the cellulose ester plastic used minus the weight of the molded article that is then divided by the weight of the cellulose ester plastic used and multiplied by 100.

DTUL, the temperature of deformation, can be measured by a three-point bending test under a variety of loads. Unless otherwise specified, as used herein, DTUL is measured by ISO 75-1/-2:2013 where the test specimen is tested via three-point bending with 0.45 MPa pressure or 1.8 MPa pressure. Unless otherwise specified, a 1.8 MPa pressure load is used. In some instances, the cellulose ester plastics described herein may have a DTUL at 0.45 MPa of about 30° C. to about 220° C. Subsets of the foregoing ranges that may also be applicable include about 30° C. to about 150° C., about 30° C. to about 110° C., about 50° C. to about 150° C., about 50° C. to about 110° C., about 70° C. to about 150° C., about 110° C. to about 200° C., 110° C. to about 150° C., or about 150° C. to about 220° C. In some instances, the cellulose ester plastics described herein may have a DTUL at 1.8 MPa of about 30° C. to about 220° C. Subsets of the foregoing ranges that may also be applicable include about 30° C. to about 150° C., about 30° C. to about 110° C., about 50° C. to about 150° C., about 50° C. to about 110° C., about 70° C. to about 150° C., about 110° C. to about 200° C., 110° C. to about 150° C., or about 150° C. to about 220° C.

The Charpy impact strength of cellulose ester plastics described herein may be measured by ISO 179-1:2010. In some embodiments, the cellulose ester plastics described herein may have a Charpy impact strength of about 1 kJ/m² to about 50 kJ/m². Subsets of the foregoing range that may also be applicable include about 1 kJ/m² to about 30 kJ/m², about 1 kJ/m² to about 20 kJ/m², 5 kJ/m² to about 50 kJ/m², 5 kJ/m² to about 30 kJ/m², about 5 kJ/m² to about 20 kJ/m², 10 kJ/m² to about 50 kJ/m², 10 kJ/m² to about 40 kJ/m², about 10 kJ/m² to about 30 kJ/m², 20 kJ/m² to about 50 kJ/m², or 20 kJ/m² to about 40 kJ/m².

The tensile modulus of cellulose ester plastics described herein may be measured by ISO 527-1:2012. In some embodiments, the cellulose ester plastics described herein may have a tensile modulus of about 1000 MPa to about 7000 MPa. Subsets of the foregoing range that may also be applicable include about 1000 MPa to about 5000 MPa, about 1000 MPa to about 3000 MPa, 2000 MPa to about 7000 MPa, 2000 MPa to about 5000 MPa, about 3000 Mpa to about 7000 Mpa, or about 4000 MPa to about 7000 MPa.

The flexural modulus of cellulose ester plastics described herein may be measured by ISO 178:2010. In some embodiments, the cellulose ester plastics described herein may have a tensile modulus of about 1000 MPa to about 8000 MPa. Subsets of the foregoing range that may also be applicable include about 1000 MPa to about 5000 MPa, about 1000 MPa to about 3000 MPa, 2000 MPa to about 8000 MPa, 2000 MPa to about 5000 MPa, about 3000 Mpa to about 8000 Mpa, or about 4000 MPa to about 8000 MPa.

Additional mechanical properties of the cellulose ester plastics that may also be maintained or improved may include, but are not limited to, tensile strength break as measured by break stress, tensile strength as measured by yield stress, flexural strength at 3.5% stress, elongation at break, elongation at yield, and IZOD notched strength.

The cellulose ester plastics of the present disclosure may have a very low haze and high transparency. The haze of cellulose ester plastics described herein may be measured by ASTM D1003-13. In some embodiments, the cellulose ester plastics described herein may have a haze of less than about 10%. Adding and increasing the concentration of fillers may increase the haze of the cellulose ester plastics. In some embodiments, the cellulose ester plastics described herein may have a haze of less than about 100%. Subsets of the foregoing ranges that may also be applicable include about 1% to about 20%, about 1% to about 10%, about 1% to about 5%, about 5% to about 50%, about 25% to about 75%, or about 50% to about 100%.

In some embodiments, the cellulose ester plastics described herein may be formed by first producing the plasticized cellulose ester by mixing (e.g., compounding, blending, high-shear mixing, etc.) the components at an elevated temperature (e.g., at about 190° C. to about 240° C.). After mixing, the plasticized cellulose ester may be extruded and formed into pellets. If the cellulose ester plastic comprises other components like a polyolefin, a compatibilizer, and the like, such components may be compounded with the cellulose ester and plasticizer. Alternatively, the plasticized cellulose ester pellets may be compounded with the additional components. By either method, a cellulose ester plastic melt is produced. The cellulose ester plastic melt may be extruded and formed into pellets for use later.

The cellulose ester plastic melt, whether as initially mixed or from pellets re-melted, may be formed into articles by a variety of methods that include, but are not limited to, injection molding, extruding (e.g., blow molding, thermoforming, film/sheet extrusion, wire coating, pipe extrusion, and the like), compression molding, rotomolding, die casting, and the like.

The ability to manipulate or otherwise tailor the foregoing properties of the cellulose ester plastics described herein may allow for applying cellulose ester plastics in previously unrealized applications and articles. Generally, the mechanical properties of cellulose esters is superior to many other polymers, but the lack of melt processability limits their application. As described herein and illustrated in the examples, the cellulose ester plastics of the present disclosure are melt processable, have a greater DTUL, and have improved mechanical properties as compared to cellulose esters plasticized with traditional plasticizers like triacetin. Therefore, the cellulose ester plastics of the present disclosure may be used in articles like vehicle interior parts where cellulose esters plasticized with traditional plasticizers could not.

Further, articles produced with the cellulose ester plastics described herein may have the added benefit of being environmentally-friendly because the cellulose ester plastics are being composed, at least partially, of a cellulose derivative that is renewable and biodegradable.

In some instances, cellulose ester plastics described herein may have a renewable content of about 20% to about 90%. As used herein, the term “renewable content” refers to the weight percent of components of a cellulose ester plastic that is made from renewable sources such as plants. Subsets of the foregoing range that may also be applicable include about 20% to about 90%, about 20% to about 75%, about 50% to about 90%, about 70% to about 85%, about 70% to about 95%, or about 70% to about 99% by weight of the cellulose ester plastic.

Exemplary articles that utilize the enhanced DTUL and mechanical properties of the cellulose ester plastics described herein may include, but are not limited to, vehicle interior parts (e.g., door handles, cup holders, dashboards, and glove boxes), appliance components, food and beverage containers, food and beverage container lids, electrical and electronic device enclosures (e.g., computer monitor enclosures, laptop enclosures, cellular phone enclosures), and the like. electrical and electronic device enclosures (e.g., computer monitor enclosures, laptop enclosures, cellular phone enclosures), and the like.

In some instances, articles that require the enhanced DTUL and mechanical properties of the cellulose ester plastics described herein also require that the articles have a low volatility. That is, less than 2% of the weight of the cellulose ester plastic is volatilized when exposed to 110° C. for 24 hours. The “percent weight loss” is calculated as follows:

$$\frac{\begin{matrix}( weight before 110 ° C . for 24 hours ) - \\ ( weight after 110 ° C . for 24 hours )\end{matrix}}{( weight before 110 ° C . for 24 hours )} * 100$$

Advantageously, at least some of the polyol benzoates have a low volatility and, therefore, are useful in producing article with a low volatility.

While the enhanced DTUL and mechanical properties are advantageous, the cellulose ester plastics described herein may be used in other articles where such enhancements may be useful but are not necessarily required. Examples of such articles may include, but are not limited to, containers and components thereof (e.g., frozen dinner containers, bottles, disposable plastic containers, lids, caps, trash cans, drawer inserts, decorative boxes, medicine bottles, and the like), furniture or components thereof (e.g., headboards, chairs, stools, and the like), picture frames, dartboards, light filters, eye glass frames, medical devices and components thereof (e.g., syringes, housings for medical devices like blood glucose meters, tongue depressors, clamps, and the like), valves, remote control housings, electrical and electronic device enclosures (e.g., computer monitor enclosures, laptop enclosures, cellular phone enclosures), and the like. electrical and electronic device enclosures (e.g., computer monitor enclosures, laptop enclosures, cellular phone enclosures), buttons, planters, and the like.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

One or more illustrative embodiments incorporating the invention embodiments disclosed herein are presented herein. Not all features of a physical implementation are described or shown in this application for the sake of clarity. It is understood that in the development of a physical embodiment incorporating the embodiments of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

Embodiments described herein include:
Embodiment A: a cellulose ester plastic comprising: a cellulose ester at about 20% to about 90% by weight of the cellulose ester plastic; and a plasticizer that comprises a carbonate ester, a polyol benzoate, or both, wherein the plasticizer is at about 2% to about 40% by weight of the cellulose ester plastic, wherein the cellulose ester plastic is melt processable;
Embodiment B: a cellulose ester plastic comprising: a plasticized cellulose ester at about 1% to about 99% by weight of the cellulose ester plastic, the plasticized cellulose ester consisting of a cellulose ester at about 60% to about 90% by weight of the plasticized cellulose ester and a plasticizer at about 10% to about 40% by weight of the plasticized cellulose ester, wherein the plasticizer comprises a carbonate ester, a polyol benzoate, or both; and a polyolefin at about 1% to about 99% by weight of the cellulose ester plastic; and wherein the cellulose ester plastic is melt processable; and
Embodiment C: a method comprising injection molding a cellulose ester plastic of Embodiment A or a plasticized cellulose ester of Embodiment B at about 190° C. to about 240° C. to form an injection molded article.

Embodiments A and C may optionally include at least one of the following elements: Element 1: the cellulose ester plastic further comprising a polyolefin at about 1% to about 75% by weight of the cellulose ester plastic; Element 2: Element 1 and wherein the cellulose ester is at about 20% to about 30% by weight of the cellulose ester plastic, the plasticizer is at about 2% to about 10% by weight of the cellulose ester plastic, and the polyolefin is at about 50% to about 75% by weight of the cellulose ester plastic; Element 3: Element 1 and the cellulose ester plastic further comprising: a compatibilizer at about 0.1% to about 20% by weight of the cellulose ester plastic; Element 4: the cellulose ester plastic consisting of the cellulose ester at about 20% to about 85% by weight of the cellulose ester plastic and the carbonate ester at about 15% to about 40% by weight of the cellulose ester plastic; and Element 5: the cellulose ester plastic consisting of the cellulose ester at about 20% to about 85% by weight of the cellulose ester plastic and the polyol benzoate at about 15% to about 40% by weight of the cellulose ester plastic.

Embodiments A, B, and C may optionally include at least one of the following elements: Element 6: wherein the plasticizer comprises the carbonate ester and the carbonate ester is at least one of: propylene carbonate, butylene carbonate, diphenyl carbonate, phenyl methyl carbonate, dicresyl carbonate, glycerin carbonate, dimethyl carbonate, diethyl carbonate, ethylene carbonate, propylene carbonate, isopropylphenyl 2-ethylhexyl carbonate, phenyl 2-ethylhexyl carbonate, isopropylphenyl isodecyl carbonate, isopropylphenyl tridecyl carbonate, or phenyl tridecyl carbonate; Element 7: wherein the plasticizer comprises the polyol benzoate and the polyol benzoate is at least one of: glyceryl tribenzoate, propylene glycol dibenzoate, diethylene glycol dibenzoate, dipropylene glycol dibenzoate, triethylene glycol dibenzoate, polyethylene glycol dibenzoate, neopentylglycol dibenzoate, trimethylolpropane tribenzoate, trimethylolethane tribenzoate, pentaerythritol tetrabenzoate, or sucrose benzoate; Element 8: wherein the plasticizer further comprises at least one other plasticizer selected from the group consisting of: triacetin, trimethyl phosphate, triethyl phosphate, tributyl phosphate, triphenyl phosphate, triethyl citrate, acetyl trimethyl citrate, acetyl triethyl citrate, acetyl tributyl citrate, tributyl-o-acetyl citrate, dibutyl phthalate, diaryl phthalate, diethyl phthalate, dimethyl phthalate, di-2-methoxyethyl phthalate, di-octyl phthalate, dibutyl tartrate, ethyl o-benzoylbenzoate, ethyl phthalyl ethyl glycolate, methyl phthalyl ethyl glycolate, n-ethyltoluenesulfonamide, o-cresyl p-toluenesulfonate, aromatic diol, substituted aromatic diols, aromatic ethers, tripropionin, tribenzoin, polycaprolactone, glycerin, glycerin esters, diacetin, glycerol acetate benzoate, polyethylene glycol, polyethylene glycol esters, polyethylene glycol diesters, di-2-ethylhexyl polyethylene glycol ester, glycerol esters, diethylene glycol, polypropylene glycol, polyglycoldiglycidyl ethers, dimethyl sulfoxide, N-methyl pyrollidinone, C₁-C₂₀ dicarboxylic acid esters, dimethyl adipate, di-butyl maleate, di-octyl maleate, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, γ-valerolactone, alkylphosphate esters, aryl phosphate esters, phospholipids, eugenol, cinnamyl alcohol, camphor, methoxy hydroxy acetophenone, vanillin, ethylvanillin, 2-phenoxyethanol, glycol ethers, glycol esters, glycol ester ethers, polyglycol ethers, polyglycol esters, ethylene glycol ethers, propylene glycol ethers, ethylene glycol esters, propylene glycol esters, polypropylene glycol esters, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, butylated hydroxytoluene, butylated hydroxyanisol, sorbitol, xylitol, ethylene diamine, piperidine, piperazine, hexamethylene diamine, triazine, triazole, pyrrole, and any combination thereof; Element 9: Element 8 and wherein the plasticizer consists of about 15% to about 85% of the carbonate ester, the polyol benzoate, or both and about 15% to about 85% of the other plasticizer; Element 10: Element 8 and wherein the plasticizer consists of about 50% to about 75% of the carbonate ester, the polyol benzoate, or both and about 25% to about 50% of the other plasticizer; and Element 11: a vehicle interior part comprising the cellulose ester plastic.

Exemplary combinations may include: two or more of Elements 1-5 in combination; Element 6 in combination with Element 7; Elements 6-7 in combination with Element 8 and optionally Element 9 or Element 10; one or more of Elements 1-5 in combination with Element 6 and/or Element 7 and optionally in further combination with Element 8; one or more of Elements 1-5 in combination with Element 8 and optionally Element 9 or Element 10; and one or more of Elements 1-11 in combination with Element 12 including the foregoing combinations.

To facilitate a better understanding of the embodiments of the present invention, the following examples of preferred or representative embodiments are given. In no way should the following examples be read to limit, or to define, the scope of the invention.

### Examples

Example 1 illustrates that the carbonate ester and polyol benzoate plasticizers described herein enhance the DTUL of cellulose ester plastics. Various cellulose ester plastic samples using different plasticizers and plasticizer concentrations were compounded at about 210° C. to about 240° C. according to the formulations in Table 1. ISO 75-1/-2:2013 was used to measure DTUL at the given loads.

TABLE 1

| | | | DTUL | DTUL | | | Charpy |
|---|---|---|---|---|---|---|---|
| | Cellulose | | at | at | Tensile | Flexure | Impact |
| | Acetate | Plasticizer | 1.8 MPa | 0.45 MPa | Modulus | Strength | Strength |
| Sample | (wt %) | (wt %) | (° C.) | (° C.) | (MPa) | (MPa) | (kJ/m²) |
| 1 | 78% | 22% GTB | 85 | 111 | 4191 | 4355 | 1.8 |
| 2 | 75% | 25% GTB | 77 | 97 | 3507 | 3794 | 1.9 |
| 3 | 72% | 28% GTB | 70 | 90 | 3074 | 3253 | 1.7 |
| 4 | 85% | 15% PRC | 94 | 113 | 5631 | 6792 | 15 |
| 5 | 80% | 20% PRC | 75 | 91 | 4302 | 5412 | 12.8 |
| 6 | 77% | 23% PRC | 61 | 76 | 4320 | 4789 | 11.9 |
| 7 | 74% | 26% PRC | 58 | 67 | 3425 | 3873 | 15.6 |
| 8 | 71% | 29% PRC | 51 | 59 | 3066 | 3246 | 16.4 |
| 9 | 82% | 18% DPC | 92 | 113 | 4228 | 4851 | 4.6 |
| 10 | 80% | 20% DPC | 79 | 105 | 4248 | 4499 | 4.8 |
| 11 | 78% | 22% DPC | 79 | 99 | 3804 | 4179 | 6.4 |
| 12 | 74% | 26% DPC | 65 | 84 | 2290 | 3265 | 8.7 |
| 13* | 84% | 17% TA | — | — | — | — | — |
| 14 | 77% | 23% TA | 70 | — | 2993 | 3375 | 8.1 |
| 15 | 74% | 26% TA | 61 | — | 2857 | 3223 | 10.3 |
| 16 | 72% | 28% TA | 59 | — | 2733 | 3027 | 8.6 |
| 17 | 67% | 33% TA | 40 | — | 1503 | 1596 | 15.1 |
| 18 | 74% | 26% TEC | 59 | — | 2396 | 2456 | 9.1 |
| 19 | 72% | 28% TEC | 49 | — | 2050 | 2152 | 10 |
| 20 | 78% | 22% DEP | 62 | 85 | 2857 | 2895 | 1.3 |
| 21 | 74% | 26% DEP | 57 | 72 | 2285 | 2436 | 5.1 |
| 22 | 72% | 28% DEP | 60 | 76 | 2347 | 2500 | 12.0 |
| 23 | 70% | 30% DEP | 57 | 74 | 1994 | 1972 | 17.6 |
| 24 | 68% | 32% DEP | 61 | — | 2179 | 2033 | 19.8 |
| 25 | 66% | 34% DEP | 46 | 58 | 1543 | 1565 | 19.8 |
| 26 | 74% | 26% ATEC | 66 | 85 | 2411 | 2612 | 8.0 |
| 27 | 72% | 14% TA | 56 | — | 2298 | 2098 | 12.8 |
| | | 14% TEC | | | | | |
| 28 | 72% | 18% TA | 53 | — | 2123 | 2139 | 11.9 |
| | | 10% TEC | | | | | |
| 29 | 72% | 18% TA | 54 | — | 2167 | 2078 | 12.25 |
| | | 7% TEC | | | | | |
| | | 3% ATEC | | | | | |
| 30 | 75% | 15% GTB | 69 | — | 3223 | 3394 | 2.3 |
| | | 10% TA | | | | | |
| 31 | 75% | 10% GTB | 70 | — | 3076 | 3216 | 3.2 |
| | | 15% ATEC | | | | | |
| 32 | 71% | 15% PRC | — | 62 | 2447 | 2649 | 13.2 |
| | | 14% TA | | | | | |
| 34 | 71% | 10% PRC | — | 67 | 2615 | 2711 | 11.5 |
| | | 19% TA | | | | | |
| 34 | 71% | 15% PRC | — | 69 | 2448 | 2617 | 12 |
| | | 14% ATEC | | | | | |
| 35 | 71% | 15% PRC | — | 76 | 2769 | 2907 | 3.6 |
| | | 14% GTB | | | | | |
| 36 | 65% | 15% PRC | — | 47 | 1892 | 1544 | 17.4 |
| | | 20% TA | | | | | |
| 37 | 65% | 15% PRC | — | 55 | 1639 | 1430 | 17.3 |
| | | 20% ATEC | | | | | |

— = not measured
*= not melt processable
CA = cellulose acetate
GTB = glyceryl tribenzoate
PRC = propylene carbonate
DPC = diphenyl carbonate
TA = triacetin
TEC = triethyl citrate
DEP = diethyl phthalate
ATEC = acetyl triethyl citrate

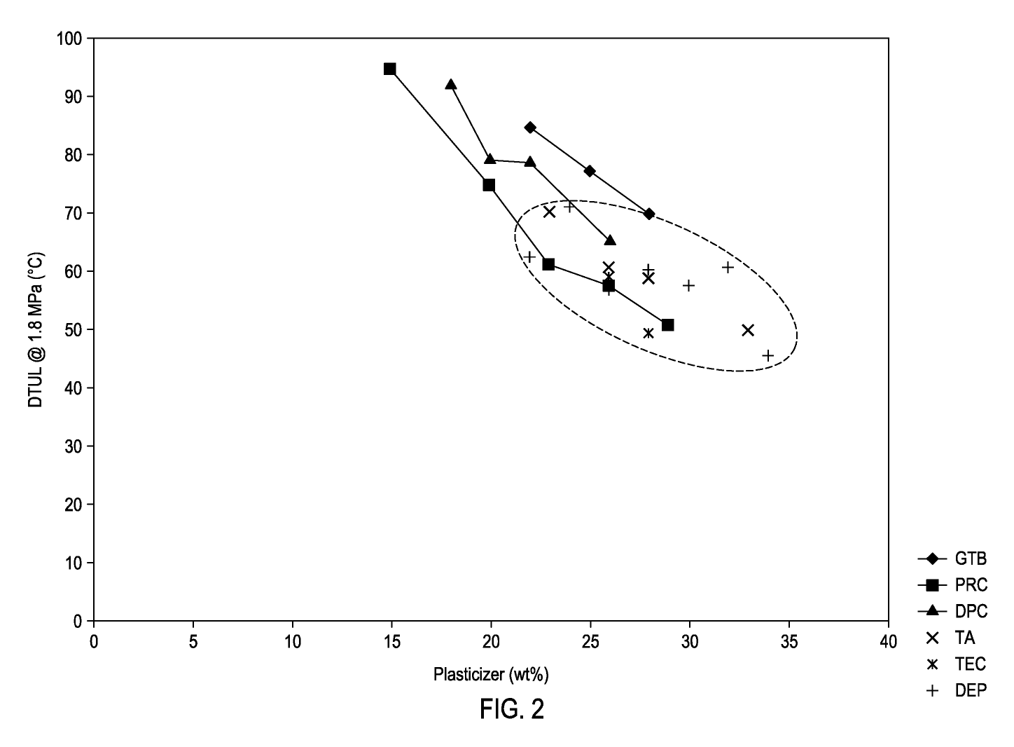

FIG. 2 is a plot of DTUL at 1.8 MPa versus the percent plasticizer for Samples 1-25 where a single plasticizer is used. The graph illustrates as plasticizer concentration increase, the DTUL decrease. Further, the traditional plasticizers have DTUL below about 70° C. and have a minimum plasticizer concentration of about 20%. As illustrated in Sample 13 of Table 1, plasticizer concentrations below 20% are not melt processable. Visually, these low concentrations of traditional plasticizers form samples that are brittle and cannot form pellets by the method described herein to be considered melt processable.

The carbonate ester and polyol benzoate plasticizers tested increased the DTUL by either being a more effective plasticizer in allowing for less concentration of plasticizer while still forming a melt processable sample or by increasing thermal performance at equivalent plasticizer levels.

Table 1 also includes mixed plasticizer samples where the use of carbonate ester and/or polyol benzoate plasticizers increases the DTUL of the sample. For example, Sample 15 with 26% triacetin had a DTUL at 1.8 MPa of about 61° C., which was raised almost 15% by replacing a portion of the triacetin with glyceryl tribenzoate in Samples 29 and 30. Another example, sample 8 with 29% PRC had a DTUL at 1.8 MPa of about 56° C. which was raised almost 29% by replacing a portion of the PRC with glyceryl tribenzoate in Samples 35.

In addition to increasing the DTUL, the propylene carbonate also increased the impact strength of the cellulose ester plastics by an order of magnitude as compared to comparable concentrations of other plasticizers.

Example 2 illustrates that the polyol benzoate plasticizers produce cellulose ester plastics with low volatility. Various plasticized cellulose acetate samples were compounded at about 190° C. to about 240° C. according to the formulations in Table 2. To measure the weight loss due to volatilization of the plasticizer, 20 g of each cellulose acetate plastic sample was first dried at room temperature in a desiccator for at least 48 hours. The weight after desiccation was recorded as the original weight. Then, the samples were exposed to 110° C. in an oven for 24 hours. As the samples were removed from the oven, they were placed back in the desiccator to cool and mitigate moisture uptake before obtaining a final weight. The weight loss during the heat treatment provides an indication of the volatility of the plasticizer in each formulation. The test were performed in triplicate with the average percent weight loss results provided in Table 2.

TABLE 2

| | Sample | | | | | |
|---|---|---|---|---|---|---|
| | 37 | 38 | 39 | 40 | 41 | 42 |
| CA (wt %) | 74 | 75 | 77 | 75 | 68 | 74 |
| GTB (wt %) | 0 | 15 | 15 | 25 | 25 | 0 |
| ATEC (wt %) | 0 | 10 | 8 | 0 | 0 | 26 |
| PEG-300 (wt %) | 0 | 0 | 0 | 0 | 7 | 0 |
| TA (wt %) | 26 | 0 | 0 | 0 | 0 | 0 |
| % Weight Loss | >2.0 | 0.51 | 0.41 | 0.10 | 0.13 | 0.63 |

PEG-300 = polyethylene glycol 300 molecular weight

Sample 37 is a formulation with a common, volatile plasticizer, triacetin and has the highest weight loss in this test. Increasing the concentration of glyceryl tribenzoate in the formulation decreases the percent weight loss, which would provide for the plasticized cellulose acetate (and consequently a cellulose ester plastic and/or article produced therefrom) to better retain its mechanical properties and DTUL over time, especially, when experiencing increased temperatures. Further, Samples 38-42 have a low volatility, which may render these samples suitable for inclusion in vehicle interior parts.

Example 3 illustrates cellulose ester plastics that include a polyolefin, specifically polypropylene, in the formulation. Various cellulose ester plastic samples were prepared with polypropylene according to the formulations in Table 3, wherein Sample 43 with no polypropylene and Sample 47 with 100% polypropylene provide comparison standards for the other samples. The methods used to measure the mechanical properties included: ISO 527-1:2012—tensile modulus, yield stress, yield strain, break stress, break strain; ISO 178:2010—flexural modulus; ISO 179-1:2010—Charpy impact strength (notched); ISO 75-1/-2:2013—DTUL at 1.8 MPa, ISO 1133—MFI (at 210° C. 2.16 kg); and Method in Example 2—% weight loss.

TABLE 3

| | Sample | | | | | | | |
|---|---|---|---|---|---|---|---|---|
| | 43 | 44 | 45 | 46 | 47 | 48 | 49 | 50 |
| PP (wt %) | 0 | 50 | 70 | 80 | 100 | 66.5 | 68.6 | 75 |
| CA (wt %) | 75 | 37.5 | 22.5 | 15 | 0 | 21.4 | 22.1 | 18.8 |
| GTB (wt %) | 25 | 12.5 | 7.5 | 5 | 0 | 7.1 | 7.3 | 3.8 |
| ATEC (wt %) | 0 | 0 | 0 | 0 | 0 | 0 | 0 | 2.5 |
| PEG-300 (wt %) | 0 | 0 | 0 | 0 | 0 | 5 | 2 | 0 |
| Tensile Modulus (MPa) | 3570 | 1442 | 1267 | 1135 | 1122 | 1135 | 1104 | 1101 |
| Yield Stress (MPa) | 99 | 0 | 0 | 0 | 21 | 18 | 13 | 15 |
| Yield Strain (%) | 5 | 0 | 0 | 0 | 5 | 4 | 3 | 3 |
| Break Stress (MPa) | 86 | 20 | 21 | 17 | 16 | 17 | 13 | 15 |
| Break Strain (%) | 4 | 2 | 4 | 4 | 31 | 6 | 4 | 4 |
| Flexural Modulus (MPa) | 4000 | 1637 | 1379 | 1205 | 1109 | 1144 | 1232 | 1123 |
| Charpy Impact | 3.1 | 4.6 | 5.1 | 6.5 | 7.7 | 7.1 | 11.2 | 9.1 |
| Strength (kJ/m²) | | | | | | | | |
| DTUL at 1.8 MPG (° C.) | 82 | 62 | 67 | 60 | 53 | 51 | 57 | 58 |
| MFI (g/10 min) | 2 | 0.43 | 0 | 7.16 | 21.1 | 23.21 | 8.09 | — |
| % Weight Loss | 0.3 | 0.17 | 0.18 | 0.19 | — | 0.26 | 0.24 | 0.41 |

PP = polypropylene

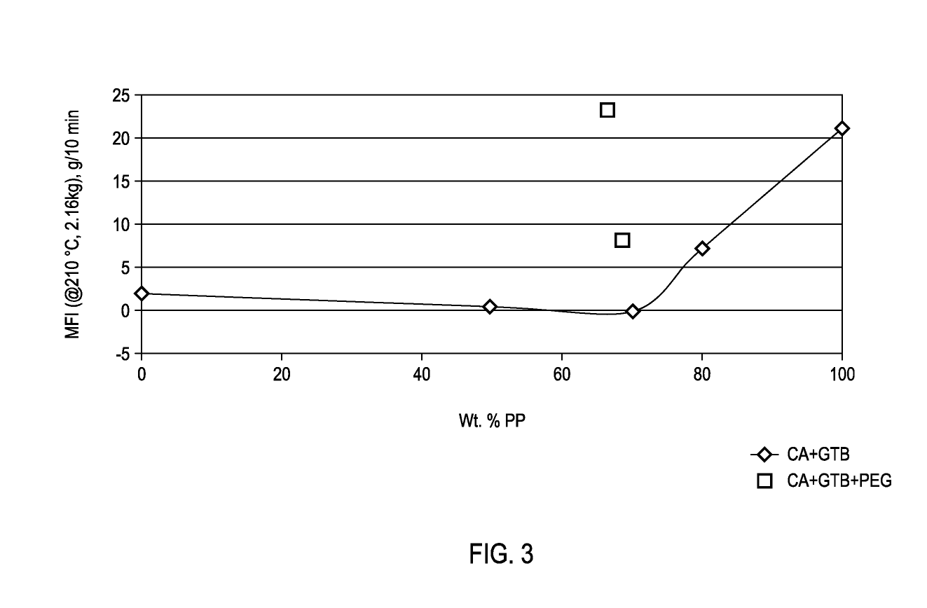

FIGS. 3-5 plot the MFI, Charpy impact strength, and % weight loss, respectively, as a function of the percent polypropylene for the foregoing samples.

FIG. 3 illustrates that the MFI increases significantly at higher polypropylene concentrations, which indicates the cellulose ester plastic is more flowable. Further, when polyethylene glycol is used as a compatibilizer, the MFI increases significantly to be comparable to polypropylene alone even with almost 33% plasticized cellulose ester included by weight of the cellulose ester plastic.

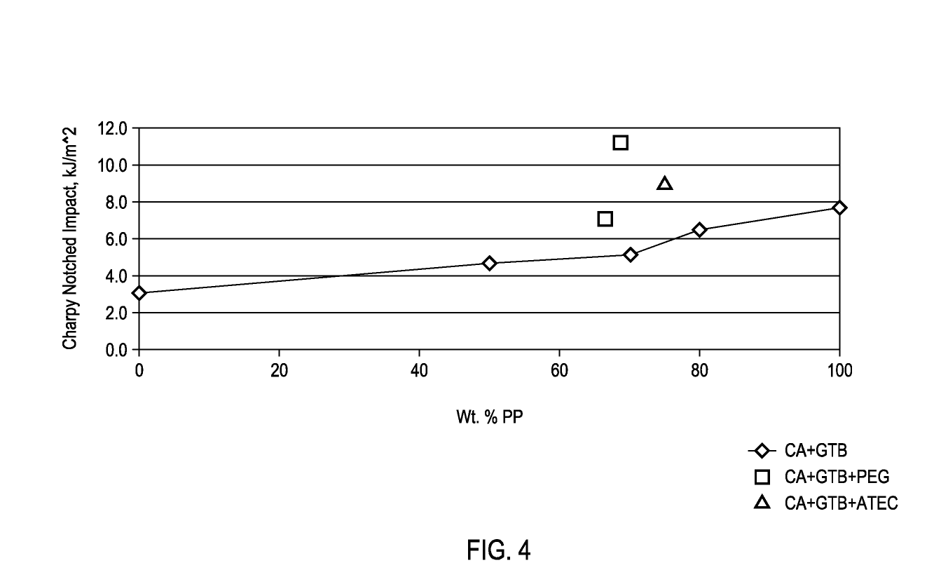

FIG. 4 illustrates that the Charpy impact strength (greater values indicate tougher materials) increases with increasing polypropylene concentration. However, when a compatibilizer like polyethylene glycol added, the cellulose ester plastics have comparable or better toughness than native polypropylene.

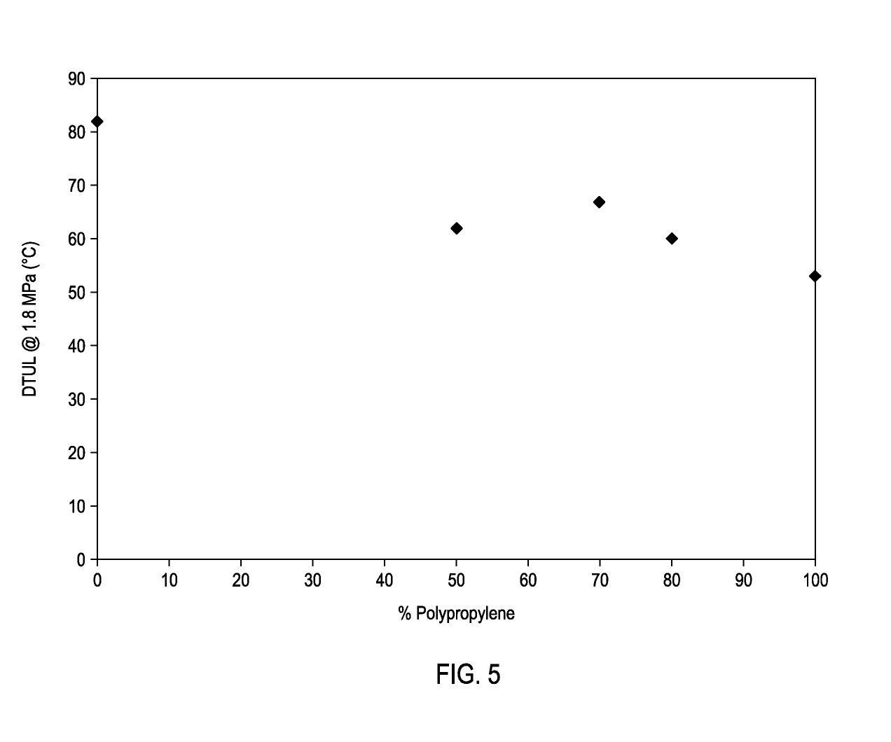

FIG. 5 illustrates that the DTUL increases with increasing plasticized cellulose acetate concentration and decreasing polypropylene concentration.

Example 3 illustrates that cellulose ester plastics comprising cellulose esters, polyol benzoates, and polypropylene are comparable to or can outperform polypropylene. Further, such formulations can be more environmentally-friendly with renewable contents of 25% or higher, in some instances.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A cellulose ester plastic comprising:
a cellulose ester at about 20% to about 90% by weight of the cellulose ester plastic; and
a plasticizer that comprises a carbonate ester, a polyol benzoate, or both, wherein the plasticizer is at about 2% to about 40% by weight of the cellulose ester plastic,
wherein the cellulose ester plastic is melt processable.

2. The cellulose ester plastic of claim 1 further comprising: a polyolefin at about 1% to about 75% by weight of the cellulose ester plastic.

3. The cellulose ester plastic of claim 2, wherein the cellulose ester is at about 20% to about 30% by weight of the cellulose ester plastic, the plasticizer is at about 2% to about 10% by weight of the cellulose ester plastic, and the polyolefin is at about 50% to about 75% by weight of the cellulose ester plastic

4. The cellulose ester plastic of claim 2 further comprising: a compatibilizer at about 0.1% to about 20% by weight of the cellulose ester plastic.

5. The cellulose ester plastic of claim 1 consisting of the cellulose ester at about 20% to about 85% by weight of the cellulose ester plastic and the carbonate ester at about 15% to about 40% by weight of the cellulose ester plastic.

6. The cellulose ester plastic of claim 1 consisting of the cellulose ester at about 20% to about 85% by weight of the cellulose ester plastic and the polyol benzoate at about 15% to about 40% by weight of the cellulose ester plastic.

7. The cellulose ester plastic of claim 1, wherein the plasticizer comprises the carbonate ester and the carbonate ester is at least one of: propylene carbonate, butylene carbonate, diphenyl carbonate, phenyl methyl carbonate, dicresyl carbonate, glycerin carbonate, dimethyl carbonate, diethyl carbonate, ethylene carbonate, propylene carbonate, isopropylphenyl 2-ethylhexyl carbonate, phenyl 2-ethylhexyl carbonate, isopropylphenyl isodecyl carbonate, isopropylphenyl tridecyl carbonate, or phenyl tridecyl carbonate.

8. The cellulose ester plastic of claim 1, wherein the plasticizer comprises the polyol benzoate and the polyol benzoate is at least one of: glyceryl tribenzoate, propylene glycol dibenzoate, diethylene glycol dibenzoate, dipropylene glycol dibenzoate, triethylene glycol dibenzoate, polyethylene glycol dibenzoate, neopentylglycol dibenzoate, trimethylolpropane tribenzoate, trimethylolethane tribenzoate, pentaerythritol tetrabenzoate, or sucrose benzoate.

9. The cellulose ester plastic of claim 1, wherein the plasticizer further comprises at least one other plasticizer selected from the group consisting of: triacetin, trimethyl phosphate, triethyl phosphate, tributyl phosphate, triphenyl phosphate, triethyl citrate, acetyl trimethyl citrate, acetyl triethyl citrate, acetyl tributyl citrate, tributyl-o-acetyl citrate, dibutyl phthalate, diaryl phthalate, diethyl phthalate, dimethyl phthalate, di-2-methoxyethyl phthalate, di-octyl phthalate, dibutyl tartrate, ethyl o-benzoylbenzoate, ethyl phthalyl ethyl glycolate, methyl phthalyl ethyl glycolate, n-ethyltoluenesulfonamide, o-cresyl p-toluenesulfonate, aromatic diol, substituted aromatic diols, aromatic ethers, tripropionin, tribenzoin, polycaprolactone, glycerin, glycerin esters, diacetin, glycerol acetate benzoate, polyethylene glycol, polyethylene glycol esters, polyethylene glycol diesters, di-2-ethylhexyl polyethylene glycol ester, glycerol esters, diethylene glycol, polypropylene glycol, polyglycoldiglycidyl ethers, dimethyl sulfoxide, N-methyl pyrollidinone, C₁-C₂₀ dicarboxylic acid esters, dimethyl adipate, di-butyl maleate, di-octyl maleate, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, γ-valerolactone, alkylphosphate esters, aryl phosphate esters, phospholipids, eugenol, cinnamyl alcohol, camphor, methoxy hydroxy acetophenone, vanillin, ethylvanillin, 2-phenoxyethanol, glycol ethers, glycol esters, glycol ester ethers, polyglycol ethers, polyglycol esters, ethylene glycol ethers, propylene glycol ethers, ethylene glycol esters, propylene glycol esters, polypropylene glycol esters, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, butylated hydroxytoluene, butylated hydroxyanisol, sorbitol, xylitol, ethylene diamine, piperidine, piperazine, hexamethylene diamine, triazine, triazole, pyrrole, and any combination thereof.

10. The cellulose ester plastic of claim 9, wherein the plasticizer consists of about 15% to about 85% of the carbonate ester, the polyol benzoate, or both and about 15% to about 85% of the other plasticizer.

11. The cellulose ester plastic of claim 9, wherein the plasticizer consists of about 50% to about 75% of the carbonate ester, the polyol benzoate, or both and about 25% to about 50% of the other plasticizer.

12. A vehicle interior part comprising the cellulose ester plastic of claim 1.

13. A cellulose ester plastic comprising:
a plasticized cellulose ester at about 1% to about 99% by weight of the cellulose ester plastic, the plasticized cellulose ester consisting of a cellulose ester at about 60% to about 90% by weight of the plasticized cellulose ester and a plasticizer at about 10% to about 40% by weight of the plasticized cellulose ester, wherein the plasticizer comprises a carbonate ester, a polyol benzoate, or both; and
a polyolefin at about 1% to about 99% by weight of the cellulose ester plastic; and
wherein the cellulose ester plastic is melt processable.

14. A method comprising:
injection molding a cellulose ester plastic at about 190° C. to about 240° C. to form an injection molded article, wherein the cellulose ester plastic comprises: a cellulose ester at about 20% to about 90% by weight of the cellulose ester plastic and a plasticizer at about 2% to about 40% by weight of the cellulose ester plastic, wherein the plasticizer includes a carbonate ester, a polyol benzoate, or both.

15. The method of claim 13, wherein the cellulose ester plastic further comprise: a polyolefin at about 1% to about 75% by weight of the cellulose ester plastic.

16. The method of claim 14, wherein the cellulose ester is at about 20% to about 30% by weight of the cellulose ester plastic, the plasticizer is at about 2% to about 10% by weight of the cellulose ester plastic, and the polyolefin is at about 50% to about 75% by weight of the cellulose ester plastic

17. The method of claim 14 further comprising: a compatibilizer at about 0.1% to about 20% by weight of the cellulose ester plastic.

18. The method of claim 13, wherein the cellulose ester plastic consists of the cellulose ester at about 20% to about 85% by weight of the cellulose ester plastic and the carbonate ester at about 15% to about 40% by weight of the cellulose ester plastic.

19. The method of claim 13, wherein the plasticizer comprises the carbonate ester and the carbonate ester is at least one of: propylene carbonate, butylene carbonate, diphenyl carbonate, phenyl methyl carbonate, dicresyl carbonate, glycerin carbonate, dimethyl carbonate, diethyl carbonate, ethylene carbonate, propylene carbonate, isopropylphenyl 2-ethylhexyl carbonate, phenyl 2-ethylhexyl carbonate, isopropylphenyl isodecyl carbonate, isopropylphenyl tridecyl carbonate, or phenyl tridecyl carbonate.

20. The method of claim 13, wherein the plasticizer comprises the polyol benzoate and the polyol benzoate is at least one of: glyceryl tribenzoate, propylene glycol dibenzoate, diethylene glycol dibenzoate, dipropylene glycol dibenzoate, triethylene glycol dibenzoate, polyethylene glycol dibenzoate, neopentylglycol dibenzoate, trimethylolpropane tribenzoate, trimethylolethane tribenzoate, pentaerythritol tetrabenzoate, or sucrose benzoate.
